(19) United States
(12) Patent Application Publication
(10) Pub. No.: US 2014/0108602 A1
(43) Pub. Date: Apr. 17, 2014

(54) METHOD AND SYSTEM FOR DELIVERING TIME-SENSITIVE, EVENT-RELEVANT INTERACTIVE DIGITAL CONTENT TO A USER DURING A SEPARATE EVENT BEING EXPERIENCED BY THE USER

(71) Applicants: Thomas Walter Barnes, Newport Beach, CA (US); Robert Morgan, Newport Beach, CA (US)

(72) Inventors: Thomas Walter Barnes, Newport Beach, CA (US); Robert Morgan, Newport Beach, CA (US)

(21) Appl. No.: 14/050,889

(22) Filed: Oct. 10, 2013

Related U.S. Application Data
(60) Provisional application No. 61/713,485, filed on Oct. 13, 2012.

(51) Int. Cl. H04L 29/08

(52) U.S. Cl. CPC H04L 67/10
USPC 709/217

(57) ABSTRACT

In a method of delivering time-sensitive, event-relevant digital content during a separate event being experienced by a user, content associated with the separate event is uploaded to a network, a sequence list is created from the newly uploaded content associated the event, and the sequence list is packaged in a mobile software application. The mobile application is delivered from the network to a mobile device of the user, and a setup for an event start time associated with the separate event is initiated so that a plurality of sequence events of event-relevant digital content, contained in the sequence list, are run in the user's mobile device in synchronization with the event start time of the separate event.

### CROSS-REFERENCE TO RELATED APPLICATION

The present application claims the benefit under 35 U.S.C. §119(e) of U.S. Provisional Patent Application No. 61/713,485 to Barnes et al., filed Oct. 13, 2012, the entire contents of which is hereby incorporated by reference herein.

### BACKGROUND

1. Field

Example embodiments generally relate to a method and system for delivering time-sensitive, event-relevant interactive digital content to a user during a separate event being experienced by the user.

2. Related Art

In an effort to enhance a viewer's experience, something known as the second screen concept is in the early stages of development. The second screen concept involves an alternate media stream delivered synchronized to a primary viewing experience. For example, alternate camera angles you can see on your phone or iPad while watching a reality live television show; additional content or viewpoints for children's cartoons delivered to a tablet; educational information delivered alongside a documentary in a classroom: user created social content to be viewed with a feature film; or additional DVD content only available via real-time download. The concept is to expand primary content with options on different smart media screens personalized and owned by individuals.

There are two primary markets for this second screen concept: broadcast television and movie-house motion picture showings. There are secondary markets emerging also like education, DVD Release, pay-per-view releases, and social user created media. This technology is based around the social media “Activity Stream” concepts, defined by Gartner Research (2013) as: “a publish-and-subscribe notification mechanism and conversation space typically found in social networking. It lists activities or events relevant to a person, group, topic or everything in the environment. A participant subscribes to, or “follows” entities (e.g., other participants or business application objects) to track their related activities.” See at http://www.gartner.com/it-glossary/activity-stream.

As this is a new concept in interactive content management for users, only a handful of efforts have been made in this area. One example system called “Second Screen” uses ‘audio watermarks’ embedded in movie audio. An audio watermark is a kind of marker covertly embedded in a noise-tolerant signal. In this example, mobile device applications ‘listen’ for watermarks which trigger smart device events. The problem with this example system is that it is not flexible, in that it requires pre-production coding. The sequence of events, once encoded, cannot be changed, and only one sequence runs per event (one event being a movie for example).

There is a substantial amount of territory to explore in developing systems which can exploit this second screen concept, so as to develop applications for interactive use by the viewer. Further, movie-house showings are more complex than delivering events to broadcast television because they represent more complex delivery scenarios, as movies shown in theaters have multiple start times during a day and are at different geographic locations, leading to potentially thousands of different activity streams.

### SUMMARY

An example embodiment is directed to a method of delivering time-sensitive, event-relevant digital content during a separate event being experienced by a user. In the method, content associated with the separate event is uploaded to a network, a sequence list is created from the newly uploaded content associated the event, and the sequence list is packaged in a mobile software application. The mobile application is delivered from the network to a mobile device of a user, and a setup for an event start time associated with the separate event is initiated so that a plurality of sequence events of event-relevant digital content, contained in the sequence list, are run in the user's mobile device in synchronization with the event start time of the separate event.

Another example embodiment is directed to a mobile software application for delivering time-sensitive, event-relevant digital content on a mobile device of a user during a separate event being experienced by the user. The application includes a sequence list stored in the application and including a plurality of sequence events of event-relevant digital content, contained in the sequence list, that are to be sequentially run in the user's mobile device in synchronization with an event start time of the separate event being experienced by the user, and a timeseed stored in the application for synchronizing the sequence list to the event start time of the separate event. The application includes means for querying whether it is time to play a sequence event from the sequence list, means for identifying the type of sequence event to be run, and means for presenting the sequence event on the user's mobile device so that the sequence event is experienced by the user during the separate event that is also being experienced by the user.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limitative of the example embodiments herein.

FIG. 1 is a block diagram of a system for delivering time-sensitive, event-relevant digital content to a user during a separate event being experienced by the user according to an example embodiment.

FIG. 2 is a flowchart of the overall system flow process for delivering time-sensitive, event-relevant digital content to a user during a separate event being experienced by the user according to an example embodiment.

FIG. 3 is a flowchart to describe the functional steps of the content publisher invoking the content publishing software according to an example embodiment.

FIG. 4 is a flow diagram to describe a mobile app processing flow.

FIG. 5 is a flow diagram to describe an event setup sub-process.

FIG. 6 is a flow diagram to describe an admin setup sub-process per movie (event) location.

FIG. 7 is a flow diagram to describe a start sequence sub-process.

FIG. 8 is a flow diagram to describe a run sequence sub-process.

FIGS. 9A and 9B is a table that describes contents in a sequence list.

FIGS. 10-12 are screenshots to illustrate example sequences in the sequence list of FIG. 9.

FIGS. 13-16 are screenshots to describe an illustrative example of the method and system described herein.

### DETAILED DESCRIPTION

As to be described hereafter, an example embodiment is directed to a method and system for delivering time-sensitive, event-relevant interactive digital content during separate events being experienced by a user. The example proprietary process and system facilitates the delivery and reception of time-sensitive and event-relevant interactive digital content to and from an end user's mobile device during events the user is attending or viewing. Example events include and can range from movies, concerts, TV Broadcast, DVD content, internet broadcasts, radio broadcasts to sports events and the like. A mobile app may be downloaded on a user's device, such as a Smartphone, tablet, iPad, laptop, PC, home cable box, DVR, and the like, so that time-sensitive and event-relevant content from these events may be synchronized and communicated between the example system and user via the app. Alternatively, users can receive and send time-sensitive content via a short message system (SMS).

In an example, and to enhance audience experience and participation, an action on screen, such as a movie, is time-synchronized with incoming text messages or a digital content feed from the system directly to/from audience smart/mobile devices as they watch the event to a dedicated social network. This may create a unique, digitally interactive experience for individuals and/or groups of liked-minded individuals during the event or anytime after the event. Accordingly, and as to be described in more detail hereafter, such may facilitate providing a unique marketing platform for future communications with registered users/subscribers.

As used herein, the term “user” means a user, registered member, or subscriber communication device accessing the example methodology described herein via the system. This is so the user may communicate with the system to have access to time-sensitive, event-relevant interactive digital content during separate events being attended or viewed by the user. A user may be a human being employing any well-known type communication device to interface and communicate with the system 100 described in detail hereafter. Example user communication or mobile devices include but are not limited to a desktop computer, notebook computer or laptop, personal digital assistant (PDA), mobile phone, tablet personal computer, RFID device, laser-based communication device, satellite-based communication device or feed, LED-based communication device, mobile navigation system, home cable box/set top box (STB), digital video recorder (DVR), mobile entertainment system, mobile information system, mobile writing system, text messaging system, etc.

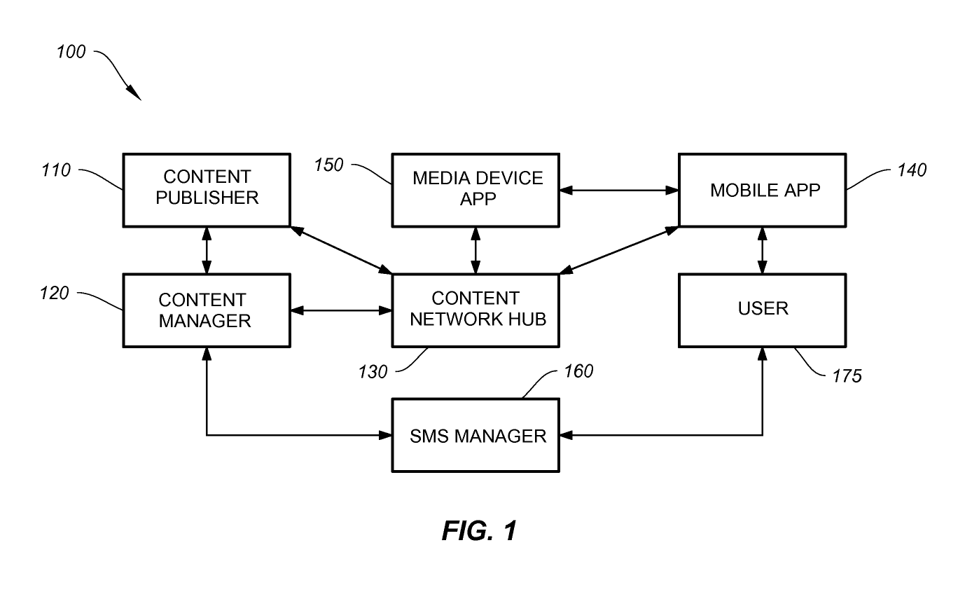

FIG. 1 is a block diagram of a system for delivering time-sensitive, event-relevant interactive digital content to a user during a separate event being experienced by the user according to an example embodiment. In FIG. 1, system 100 includes a content publisher 110, a content manager 120, a content network hub 130, a mobile app 140, a media device app 150, an SMS manager 160, and one or more users 175.

The content publisher 110 is a complete content generator and content management system. Proprietary software stored in software under the control of the content manager 120 has been designed for the content publisher 110, (i.e., person that is responsible for generating content, for example, a director, writer, producer, distributor of content such as a movie or broadcast content such as a television program). Content publisher (CP) software accessed by the content publisher 110 may reside on a computing device embodied by a server on network hub 130 or a notebook/desktop computer configured to operate as a storage server; an ASUS® TS500-E6/PS4 tower-style storage server is just one (of many) examples of a suitable content publisher software. Alternatively the content publisher 110 may access the CP software using known cloud computing and storage processes via content network hub 130.

The content manager 120 is also a physical person, who accesses content management software (CMS) residing on a server of the network 130. The content manager 120 and their associated CMS represent a complete back-end management system that archives, stores and manages all aspects of the completed content programs. The content manager 120 identifies the content publisher 110 content by several searchable criteria, including by name, date, time and event category, for example. Content can be delivered to the user 175 directly via mobile app 140, media device app 150, via SMS manager 160, or by other available digital media. The CMS accessed and controlled by content manager 120 may also reside on a computing device such as a tower-style server that forms part of the infrastructure of network hub 130. Alternatively the content manager 120 may access the CP software using known cloud computing and storage processes via content network hub 130. The content manager 120 executes an event (movie) setup process, as to be described in more detail hereafter.

The content publisher 110 logs into proprietary CP software running on the CMS server controlled by content manager 120, enters the desired content messages, and enters the exact time synchronized intervals for content to be delivered via an event setup process to be described hereafter. This upload is accepted by non-member users 175 and/or member subscribers. The event is then staged for delivery to user 175 via a start sequence outlined in detail later below, which is initiated by an admin setup sequence (per event location) outlined in detail hereafter.

The network hub 130 is a proprietary software hub that manages all aspects of system 100 operation including, but not limited to, content, delivery, user base, membership controls, mobile downloads, social sharing, streaming and SMS system. The network hub 130 may be embodied by one or more networking database servers or a notebook/desktop computer configured to operate as a network server. One example may be an Oracle® Sun™ server. In a further example, the server(s) of network hub 130 may form part of the CMS server of content manager 120, i.e., may be part of the network hub 130 infrastructure (hardware and/or software/firmware), or vice versa. In a further example, one or more databases stored in one or more servers forming network hub 130 may be adapted to be transmitted, transferred, transformed and/or translated to or from the server containing the CMS and/or CP software for content manager 120 and content publisher 110.

In general, an app, or web application, is an application that is accessed by users over a network such as the Internet or an intranet. The term may also mean a computer software application that is coded in a browser-supported programming language (such as JavaScript, combined with a browser-rendered markup language like HTML) and reliant on a common web browser to render the application executable.

Web applications are popular due to the ubiquity of web browsers, and the convenience of using a web browser as a client, sometimes called a thin client. The ability to update and maintain web applications without distributing and installing software on potentially thousands of client computers is a key reason for their popularity, as is the inherent support for cross-platform compatibility. Common web applications include webmail, online retail sales, online auctions, wikis and many other functions.

An iPhone® app is an application, typically developed by a company other than Apple®, and designed to be used specifically on the iPhone®, iPad® or iPod Touch®. Apps work much like user-installed software on a computer and allow the phone to perform specific tasks that the user wants or needs. Users sometimes pay a small fee for the use of an app, which is downloaded directly to the phone. Apps helped make the iPhone® and other smartphones a must-have tool for many people who want instant access to information.

An Android® app is a mobile software application developed for use on devices powered by Google®'s Android platform. Android apps are available in the Google Play Store (formerly known as the Android Market), in the Amazon® Appstore and on various Android App-focused websites, and the apps can run on Android smartphones, tablets, Google TV and other devices.

As with Apple and its Apple App Store apps, Google encourages developers to program their own Android apps. While many Android apps can be freely downloaded, premium apps are also available for purchase by users, with revenues for the latter shared between Google (30%) and the software developer (70%). Additionally, some Android Apps follow the “freemium” business model, wherein the app developer can derive revenue on free apps via Google's in-app billing capabilities.

The mobile app 140 is thus in one example designed to run on the Apple iPhone, iPad, iPod Touch, Google Android, and Windows platform, most smart phones, and laptop/notebooks. The mobile app 140 accordingly is downloaded by the user 175 from the user 175's app store or an affiliated location in the content network hub 130. Content is updated every time the user 175 logs in, can be updated with the mobile app 140 automatically when logged in, or can be selected by event title.

Once the mobile app 140 is downloaded, the user 175 opens the mobile app 140 and selects an event. Content is then downloaded to the user 175 from the content network hub 130 as pre-programmed, time-synchronized digital content. Content can also be updated every time the user 175 logs in, or can be updated with the mobile app 140 automatically when logged in.

Users 175 can also join the system 100 (network 130 in system 100) as a registered member to interact with social media site(s) and cross link messages and feedback to other social media sites (e.g., Twitter, Facebook, etc.) to interact with like-minded individuals/groups, receive promos, special offers, additional features, and the like.

The media device app 150 is similar to the mobile app in all respects: however, it is designed to run on a media device such as a Home DVR, TV, and/or cable STB system. Where the user 175 is configured in this orientation, the user 175 can access and download event content to a media device app 150 app that resides on a media device. Messages/digital content can be delivered via the content publisher 110, content manager 120, and content network hub 130 via app 150 to the media device, or more directly to a display screen connected thereto during event playback or broadcast.

System 100 is also programmed to alternatively launch timed text messages (instead of direct digital content) in sync with an action on screen or event being attended. The content publisher 110 uploads completed event-relevant content to the content manager 120 which in turn is placed on the content network hub 130. This content upload is accepted by the content manager 120 and uploaded on the main network hub 130) and waits for prompts to start sending the time-synchronized content via, in one example only, text message under control of SMS manager 160, as programmed by the content manager 120.

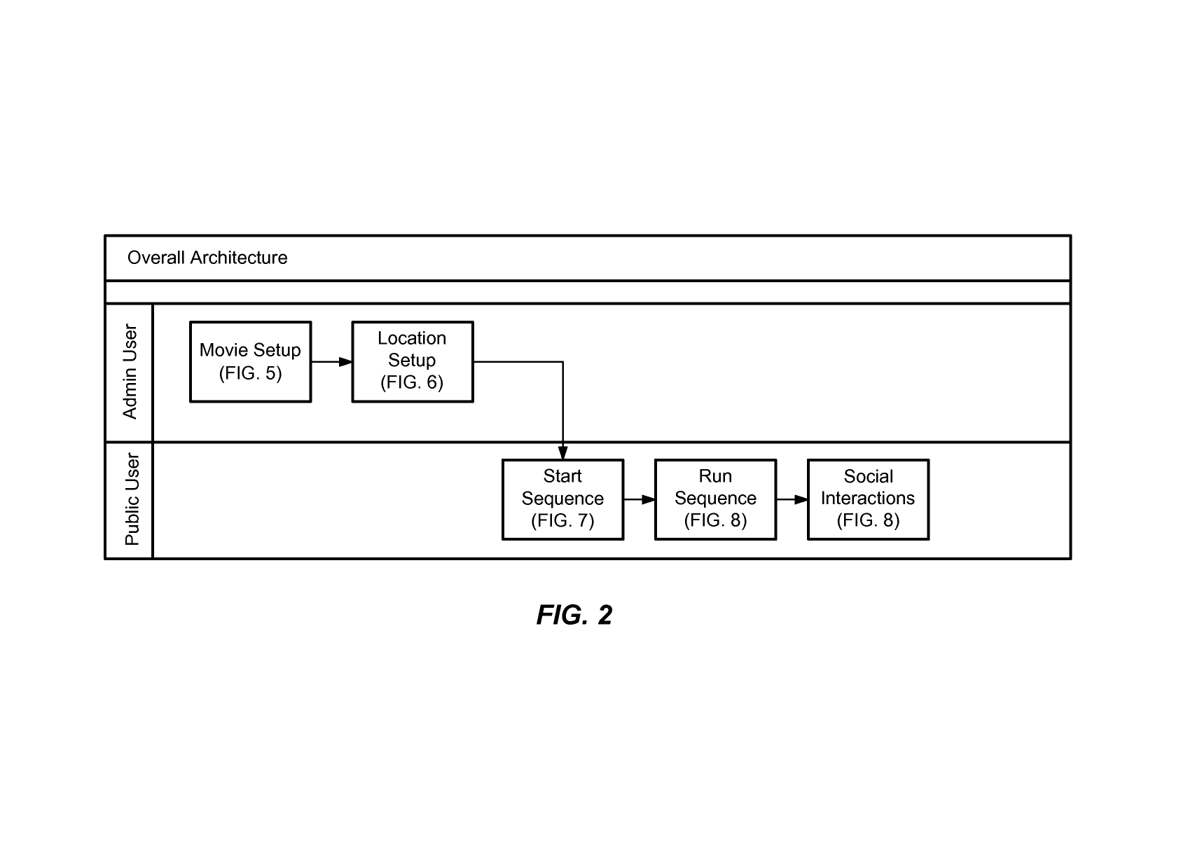

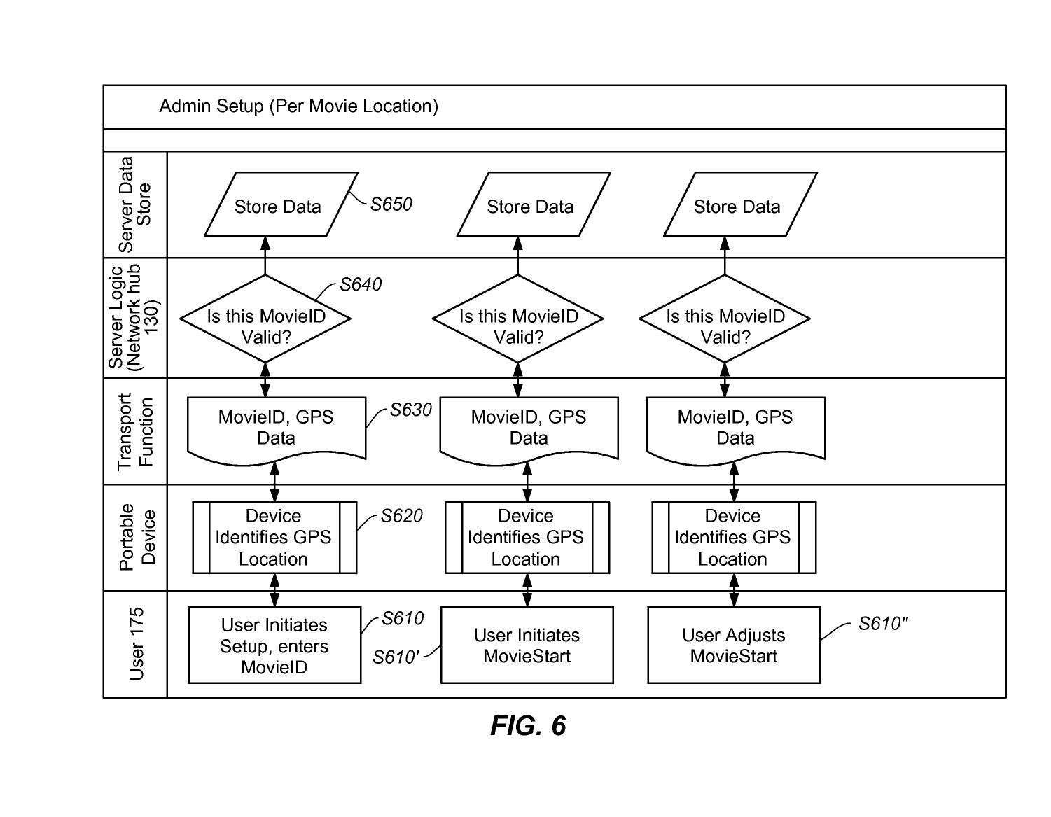

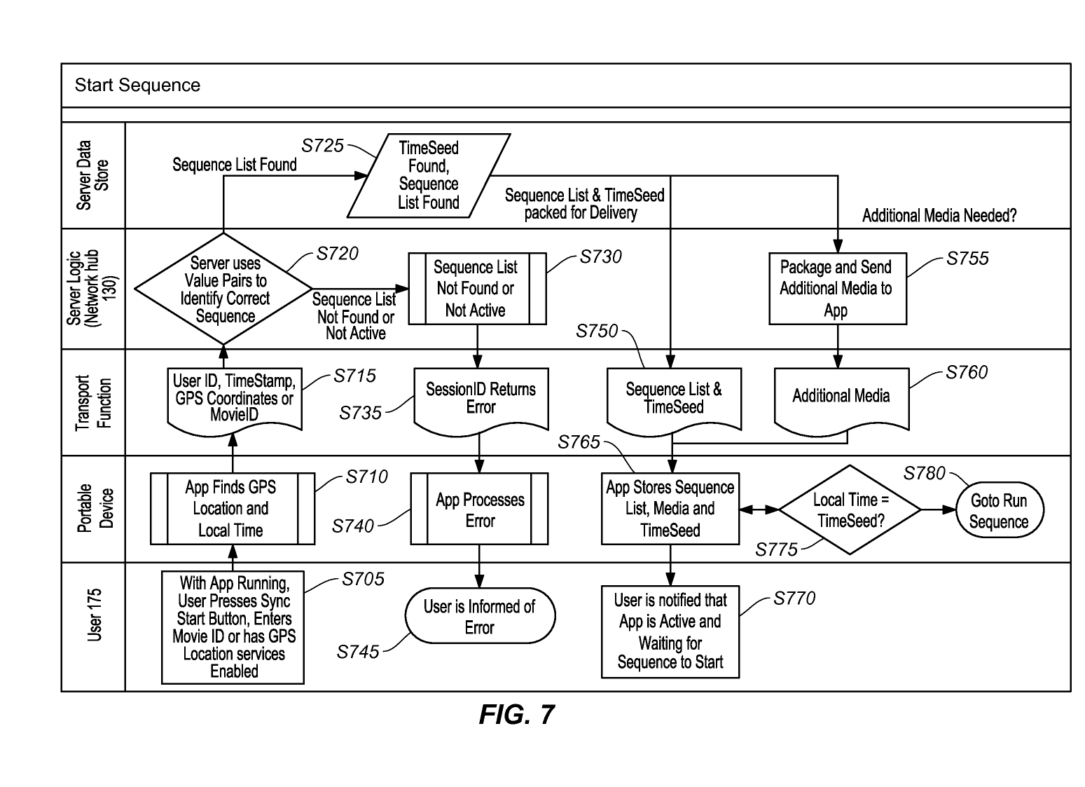

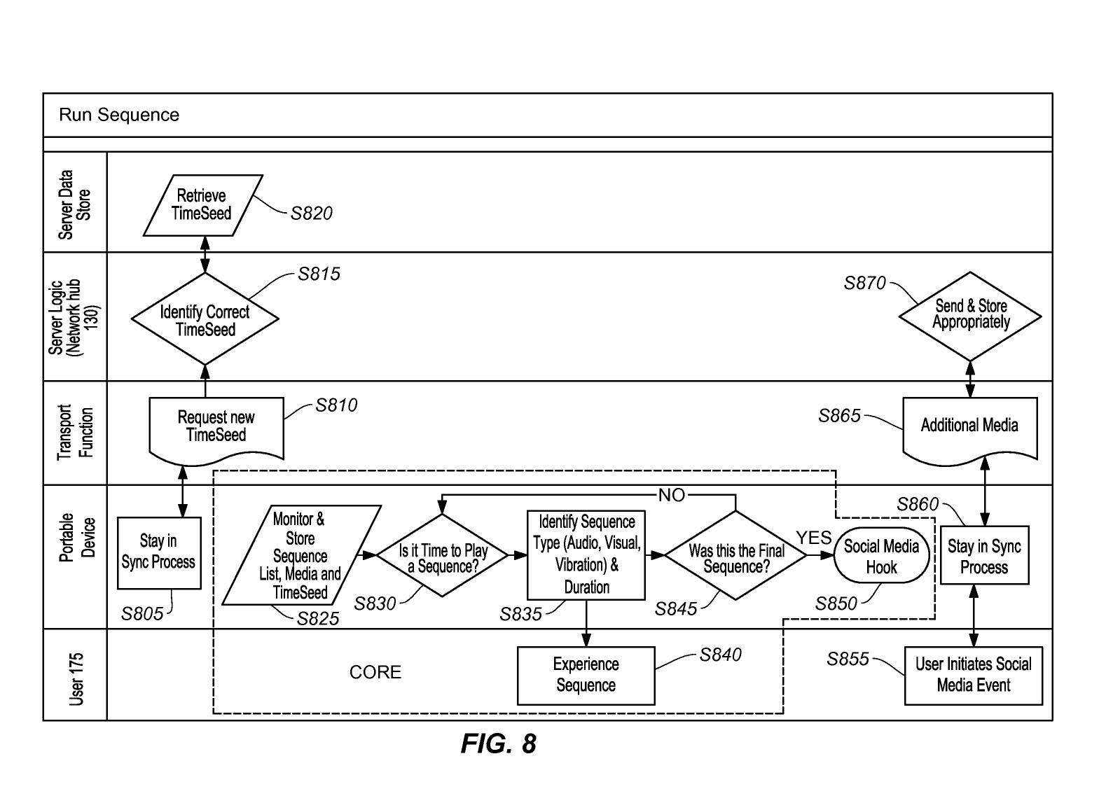

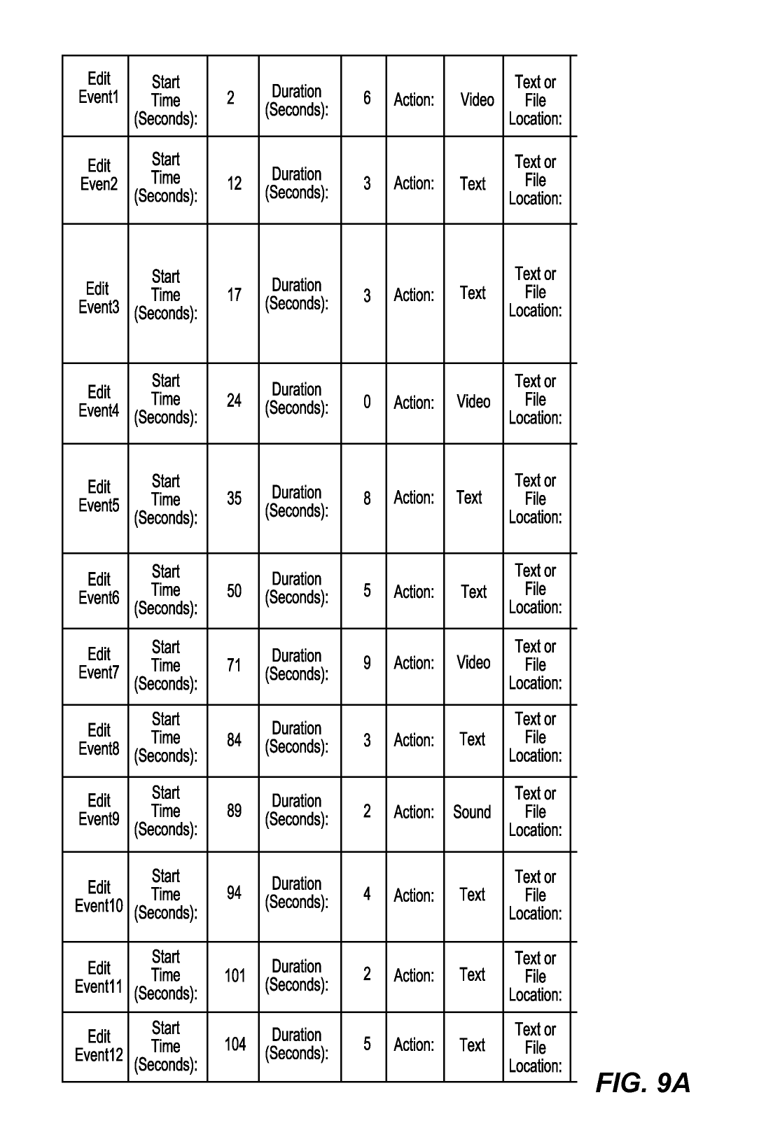

FIG. 2 shows the process flow and context of FIG. 1 in the Public User and Admin user swim lane and illustrates the five major system functions in general sequence order. This includes a movie setup process (FIG. 5), a location setup process (FIG. 6), a start sequence (FIG. 7), a run sequence (FIG. 8), and a social interactions process (FIG. 8). Each of these sub-processes is explained in detail according to their associated figure.

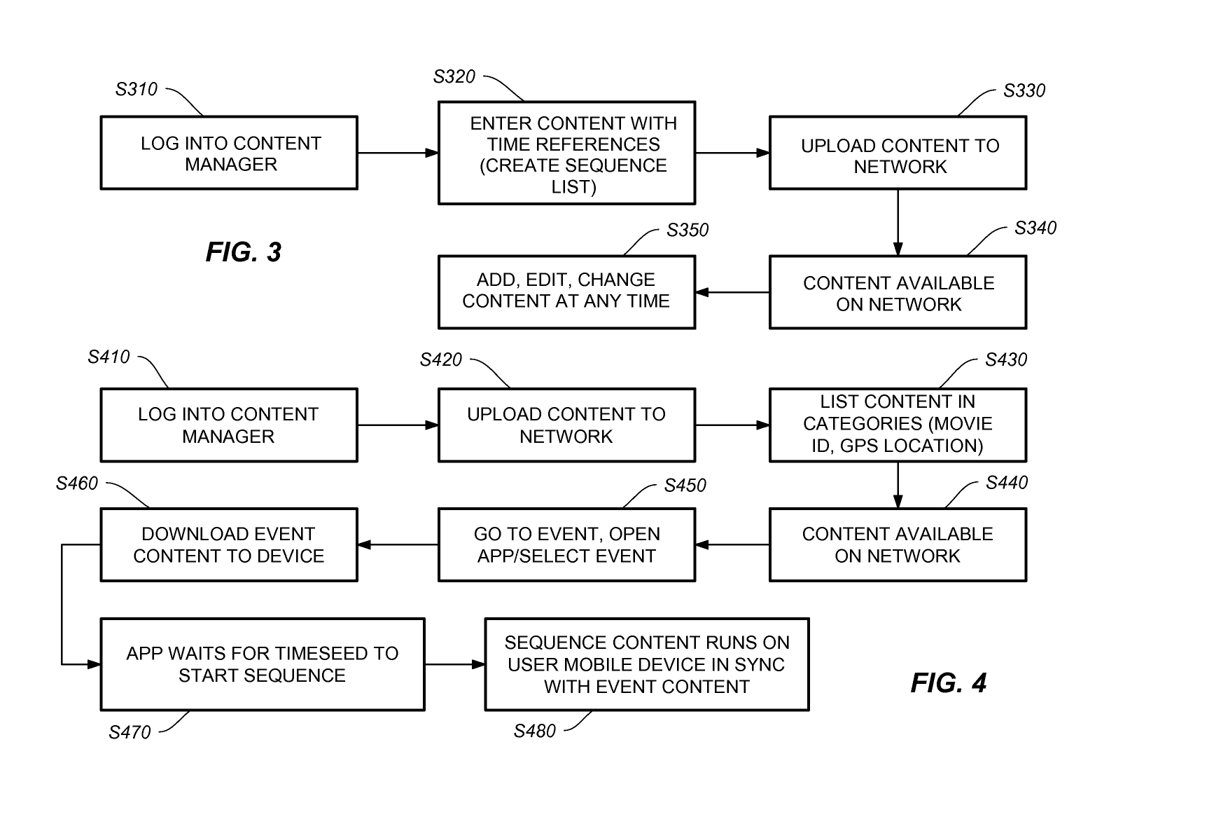

FIG. 3 is a flowchart to describe general functional steps of the content publisher invoking the content publishing software according to an example embodiment. Referring to FIG. 3, and in general, the content publisher 110 initially logs into (S310) the content manager software with permissions, and enters selected event-relevant content with time references at S320. The event-relevant content is uploaded onto the network 130 at S330. This is made available (organized into sequence lists and made available for access) to users 175 on the network at S340. At S350, the content publisher 110 can add, edit, and/or change content at any time; updates are effective at any time the publisher 110 desires.

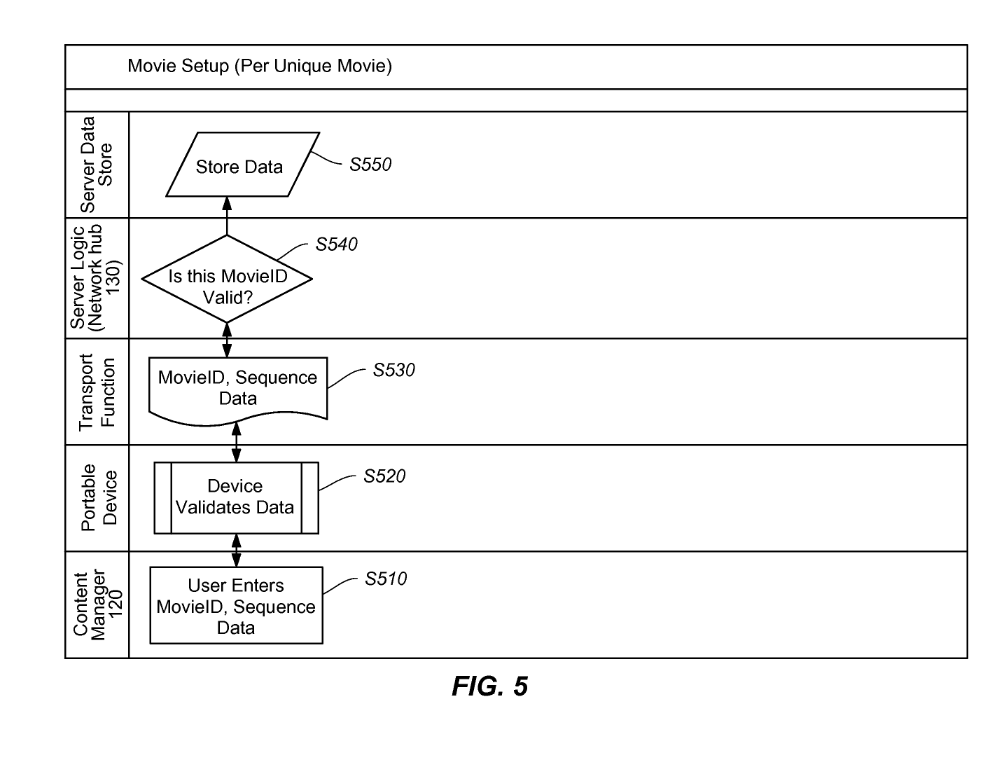

FIG. 4 is a flow diagram to describe a general mobile app processing flow. At S410, an approved content publisher 110 logs into the network 130; this is done at the content manager 120. The content publisher 110 uploads the content (5420) to the network 130 and the content manager 120 lists (S430) the new content in the appropriate category (e.g., MovieID, GPS location) on network 130. The content is then made available (S440) on the network 130 for download.

A user 175 then goes to an event (such as a concert), opens mobile app 140, and selects the event (S450). The mobile app 140 downloads (S460) the event content to the user 175. The app 140 on the user's mobile device then waits for the timeseed to start the sequence list (S470) and thereafter the sequence list content (event-relevant content) runs on the user's mobile device in synchronization with the actual, separate event content being viewed by the user 175 (S480). During the event, the user 175 thus receives event-relevant content from the sequence list that is in synchronization with the separate event content they are attending or experiencing.

As a simplistic example, one can picture a live concert being attended, with the concert producer having uploaded content to network hub 130 to be distributed out to users upon a certain song being sung. The user (a girl) has coded in a text to get access to the network 130 and gets initial content to text 56738 at “I wanna hold your hand”. As that song begins, she (and thousands of others in attendance) enters the text so that synchronization is triggered, and she receives additional social media streams off of the sequence list at designated time intervals corresponding to the concert event, such as uploaded photos, promos, lyrics, song titles, playlists, future events, in real-time, during the concert.

FIGS. 5-8 are provided to better understand the actions performed by the admin side (content manager 120) and/or by the user 175 between setup functions for an event, starting of a sequence list, the running of a sequence event, and social interactions, first presented in FIG. 2.

FIG. 5 describes the event setup sub-process, here characterized by a “movie” setup for purposes of explanation only. This is done per unique movie (unique and separate event that is to be viewed by the user 175). In FIG. 5, the user is the content manager 120, who enters the MovieID and sequence data for the sequence list (i.e., event-related content) (S510). This data is validated by a web page or application at S520, then transported (S530) to the server at content network hub 130. Server logic checks whether the Movie ID is valid against an ID stored in its database (S540), and if it checks out stores the MovieID and associated sequence list data in a data store (S550) of the server at network hub 130. The unique movie (event) sequence timings for the sequence list and media/content is now setup in the database of the server at hub 130 and has an associated Movie ID (event ID) that can be referenced by a location setup sub-process, to be described hereafter.

FIG. 6 describes an admin setup sub-process per movie (event) location. Here there are three almost identical logic streams for location setup, to account for three different scenarios. The first is where the user 175 initiates location setup by entering a MovieID (S610). The user 175's mobile device identifies its own GPS location so as to compare it to the known GPS location of the event (S620) and both the GPS data and MovieID are transported (S630) to the server at content network hub 130. Server logic checks whether the Movie ID is valid against an ID stored in its database (S640), and if it checks out stores the MovieID and associated GPS location data of the mobile device in a data store (S650) of the server at network hub 130. Alternatively, the mobile device of user 175 can pass its GPS location to the server, and a Movie ID of the event is given back to the mobile device. Accordingly, the movie location is now setup in the database of the server at network hub 130 and is able to localize application events and content with the movie (event) being shown at this location.

The second scenario is where the user initiates the start of the movie with the appropriate timeseed (S610′). The timeseed can be understood as the start time of the movie synchronized with the sequence list. This is done by user 175 and starts the selected sequence list for a showing at the GPS location recorded and stored previously in the database of the server on hub 130. The processes S620-S650 are completed in this second logic stream as well.

The third scenario accounts for drift between the start time and the current local time (i.e. event start time); user adjusts MovieStart (S610″). The processes S620-S650 are completed in this third logic stream as well. An update may be sent to the user 175. This process allows the user 175 to adjust the initial sequence start time in case of an error in the original entry, for example, the entry made by the user 175 in the second logic stream described above.

FIG. 7 is a sub-process to describe a start sequence according to an example embodiment. In FIG. 7 the app 140 has already been downloaded; this figure builds on function S470 of FIG. 4 to more fully describe the inter-workings behind the start sequence.

The user 175 may have three different ways of getting to the timeseed, upon which the run sequence initiates and event-relevant content from the sequence list is displayed on the user's mobile device in synchronization with event content of the event being attended or viewed/experienced. With the app 140 running the user can press a sync start button on their mobile device, enter a movie ID, or enable their GPS location services (S705). The app 140 on the mobile device then finds the GPS location and local time of the user 175 (S710), upon which one or more of a UserID, MovieID, timestamp, or GPS coordinates are transported (S715) to the server at network hub 130.

Server logic then evaluates value pairs of sequence lists and authorized GPS locations (S720) to identify the correct sequence list. If the sequence list is not found or not active (S730) based on the value pair evaluation, a SessionID returns an error (S735), the app 140 processes an error (S740) and the user 175 is informed of an error (S745). One example scenario in which an error would be generated is where the user hits the start sync button in the parking lot of the movie theater, or there is no corresponding GPS location for the start time.

If the sequence list is found, the timeseed is also found (S725) so the app 140 can run content local to its mobile device from the master timeseed, and both are packed for delivery (S750) to the app 140. There is also an opportunity to package and send additional media to the app 140 (S755). For example, if there are updates not in the original app 140 downloaded, these updates can be sent along with post-production media (S760). The app 140 stores the sequence list, any additional media and the timeseed (S765). The user is notified that the app 140 is active and waiting for the sequence list to start (S770). Once the local time (i.e., the event start time) equals the timeseed (YES at S775), the run sequence is initiated (S780). Accordingly, the start sequence sub-process matches up a timeseed of the sequence list with the event start time associated with the separate event being viewed or experienced by the user, to ensure that each of the plurality of sequence events displayed on the user's mobile device is in synchronization with a running time of the separate event after its event start time.

FIG. 8 is a sub-process to describe a run sequence according to an example embodiment. In FIG. 8, three processes are run concurrently. One process is to ensure that the user 175 always has the correct timeseed. The user 175's portable device checks every few seconds (stay in sync S805) with the server at the network hub 130 to make sure it has the correct timeseed. In the event it does not, a query is sent (S810) to the server requesting a new timeseed. Server logic then identifies the correct time seed (S815) and the correct timeseed is retrieved from the data store (S820) at network hub 130. This process stream accounts for unplanned events such as power outages where the timeseed at the user 175's mobile device becomes inaccurate.

A core process also runs in application 140. This is the process to begin to iterate the sequence list when the timeseed equals the start time of the event, i.e., in synchronization. The app 140 confirms that the sequence list, timeseed and media are downloaded therein (S825), then a query occurs as to whether it is time to play a sequence event from the sequence list (S830). The type of sequence event is identified by the app 140 (S835) and the sequence event is experienced by user 175 (S840) such that it is presented or displayed on the user's mobile device.

Functions S830, S835, and S840 repeat for each sequence event in the sequence list until the final sequence event is experienced (“YES” at S845), whereupon the user 175 is presented with a social media hook (S850). The social media hook signifies that the user 175 can send information through the app 140 up to a social media site accessible on the network hub 130, such as facebook, Twitter, etc. For example, this information can be commentary/recommendations on the event just viewed, commentary or remarks/recommendations on one or more of the sequence events just viewed on their mobile device in synch with the event, etc.

The user 175 can leave the sequence events of the sequence list to post a social media narrative, and return to the sequence events. Function S855 enables the user to initiate a social media event (“This movie is cool!”) and post it to a social media website such as facebook, Twitter, etc. Function S860 ensures that the user maintains the correct timeseed so that the user 175 can return to the appropriate point in the sequence list. The social media event is sent from the user 175 (S865) to the server at the network hub 130 where it may be sent to the appropriate social media website and/or stored (S870).

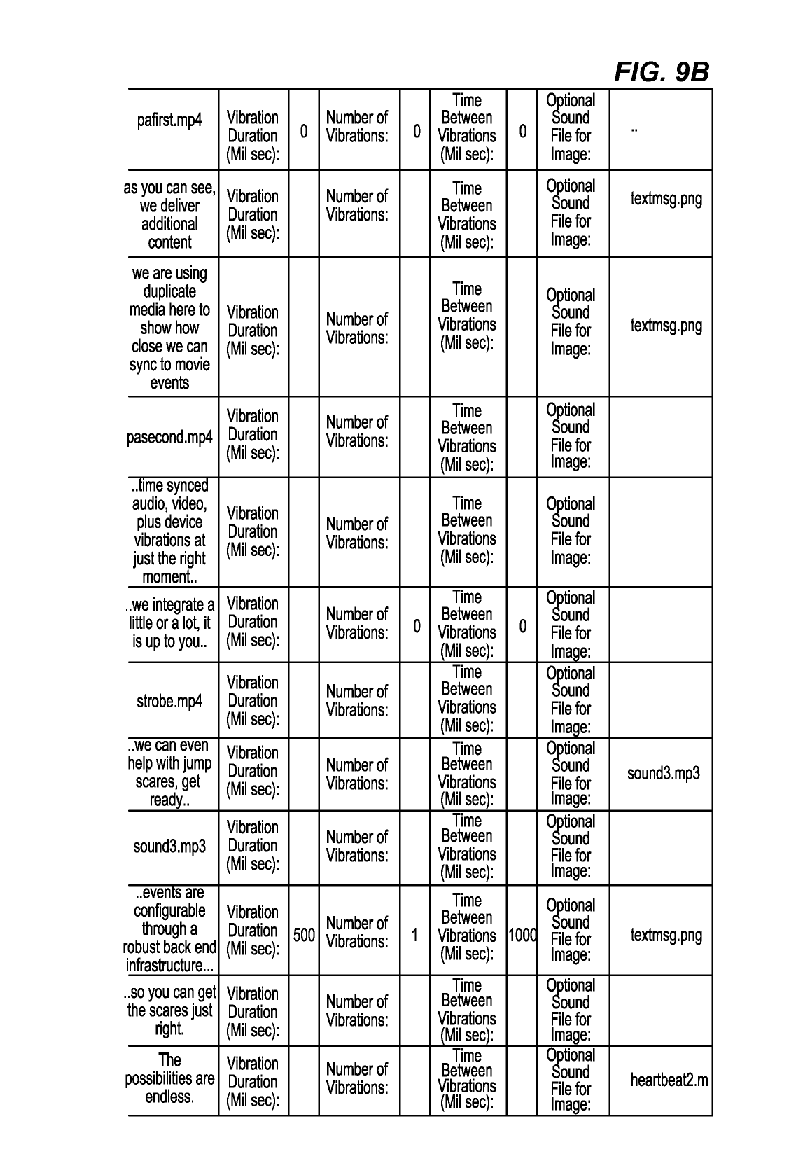

FIGS. 9A and 9B is an example sequence list of event-related data. Each of the sequence events in the list will display on the mobile device of the user 175 in sync with the event start time, in order. This is the type of sequence list that is initially prepared by the content publisher 110 and uploaded by the content manager 120 onto the server of network hub 130, for download to the app 140.

Each sequence event is designated by its event number, the start time (after the timeseed or start time of synched, separate event), a duration of the sequence, an action (text, video, device vibration, image or sound), and the text or file location for the text, video file, vibration, image file, or sound file. Certain sequences may also include additional vibrations and an additional sound, image or text file; event 10 shown in FIG. 9 being merely one example in this sequence list.

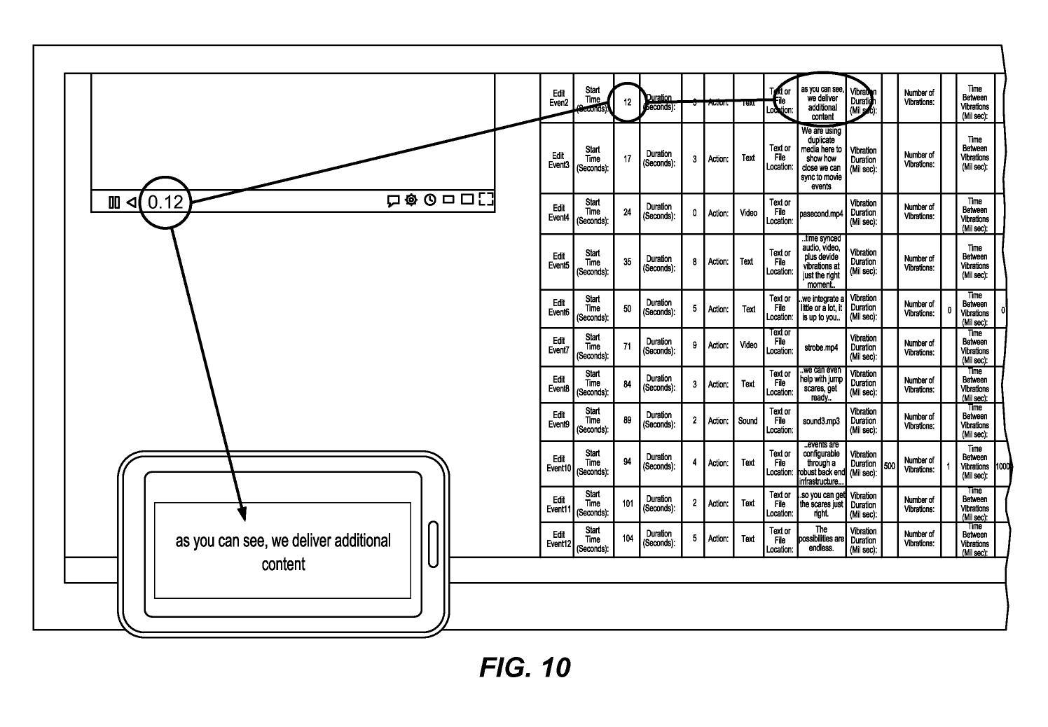

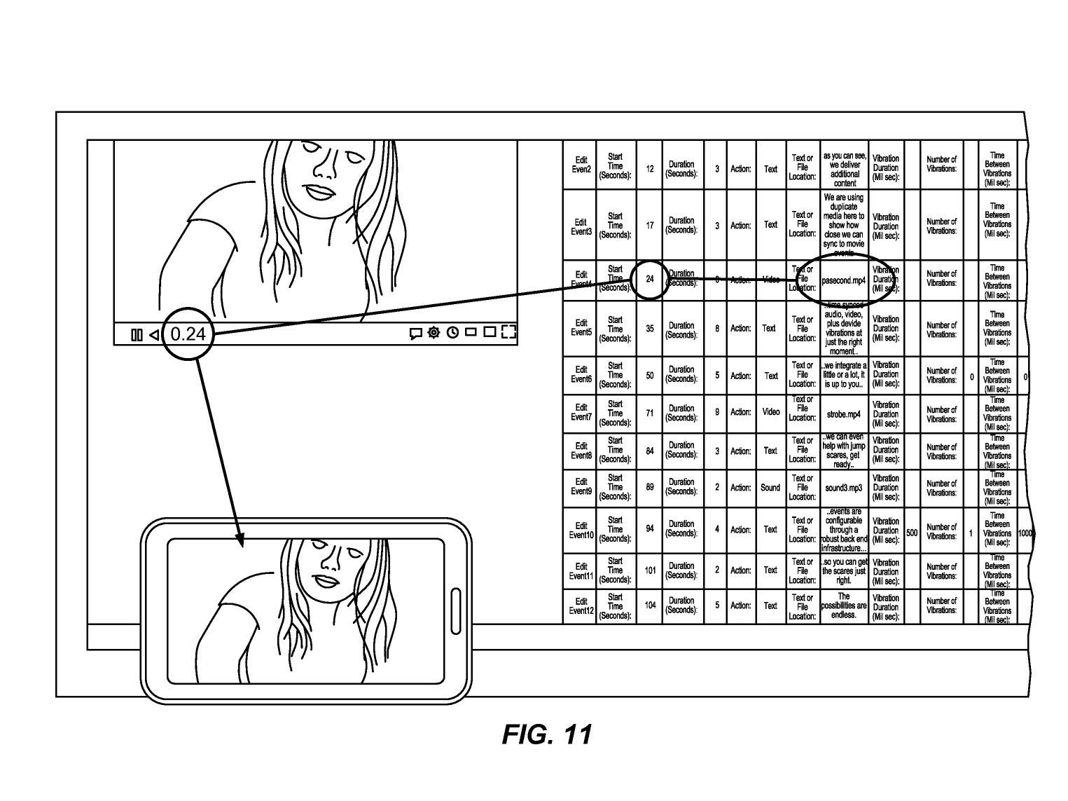

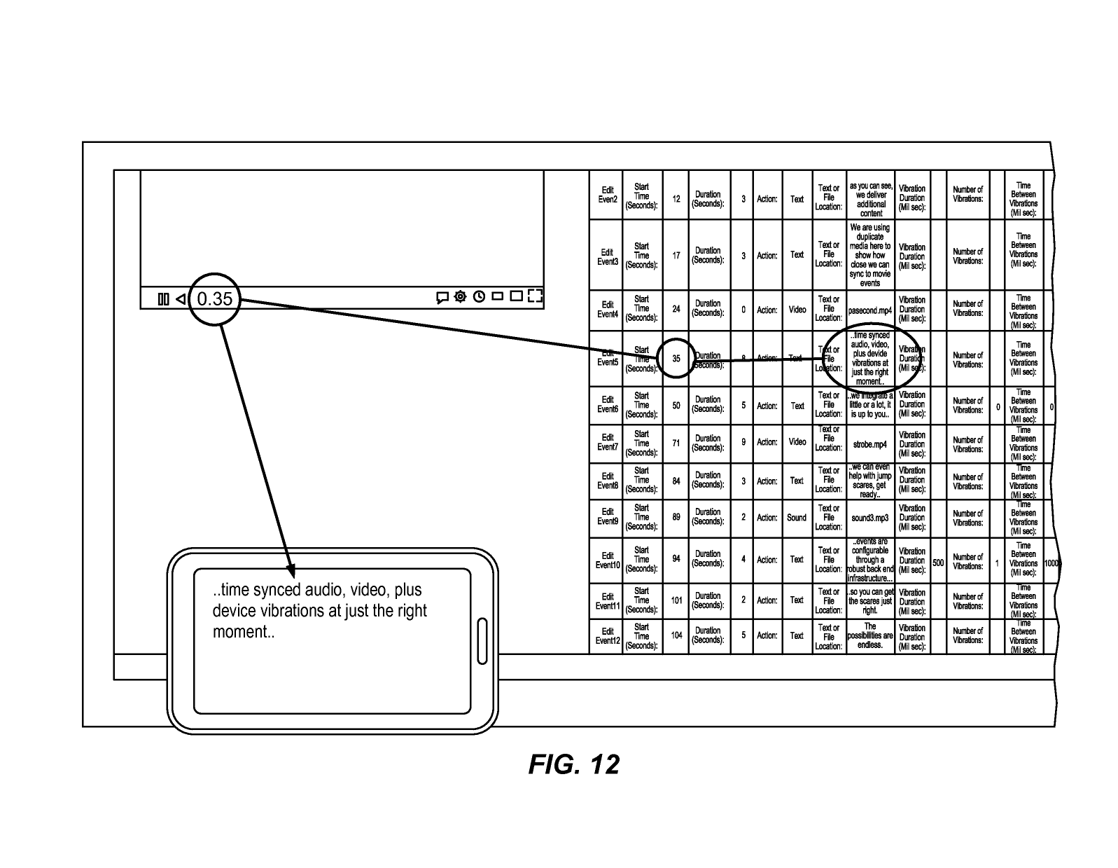

FIGS. 10-12 illustrate example sequence events in the sequence list of FIG. 9. FIGS. 10-12 each show a screenshot of a movie event playing (left-hand side), part of the sequence list of FIGS. 9A and 9B (right-hand side) and a mobile device of a user who has the app 140 downloaded thereon with the sequence list and timeseed. FIG. 10 shows sequence event 2, text which says “as you can see, we deliver additional content”. This event-related content from the sequence list is in sync with the movie event time of 12 seconds in (running time) after start of the movie event, as shown by the circles. Similarly in FIG. 11, duplicate video (sequence event 4) is shown on the user' 175's mobile device. The video is shown having run 24 seconds in after event start, thus it is the sync with the current movie event time of 24 seconds after start. FIG. 12 shows sequence event 5, text which says “ . . . audio, video, plus device vibrations at just the right moment . . . ”. This text is in sync with the movie event time of 35 seconds in (running time) after start time of the movie event (e.g., software-synchronized event).

Accordingly, the method and system described herein facilitate interactive digital communications, time-synchronized with parallel events (Movies, TV, Net, etc.) via software digital communications technologies. There is a high degree of plasticity, as both inbound and outbound content is expandable. Content communication via a synchronized social network allows individual and group interaction of like-minded users (blogs, chat rooms, event-based social interaction/viral expansion) in real time and in future related to specific, time-synchronized events. System 100 can send digital marketing, other timed content to registered members in real time during the event as well as in the future (texts, photos, coupons, offers, music, news, etc.).

### EXAMPLE

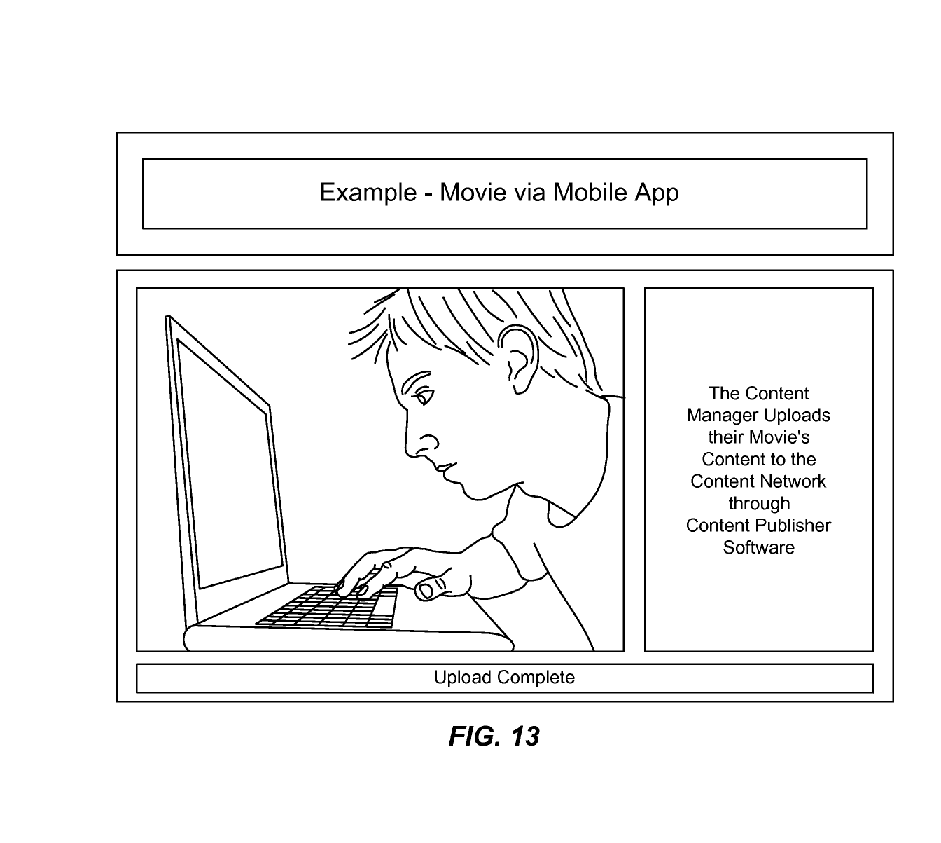

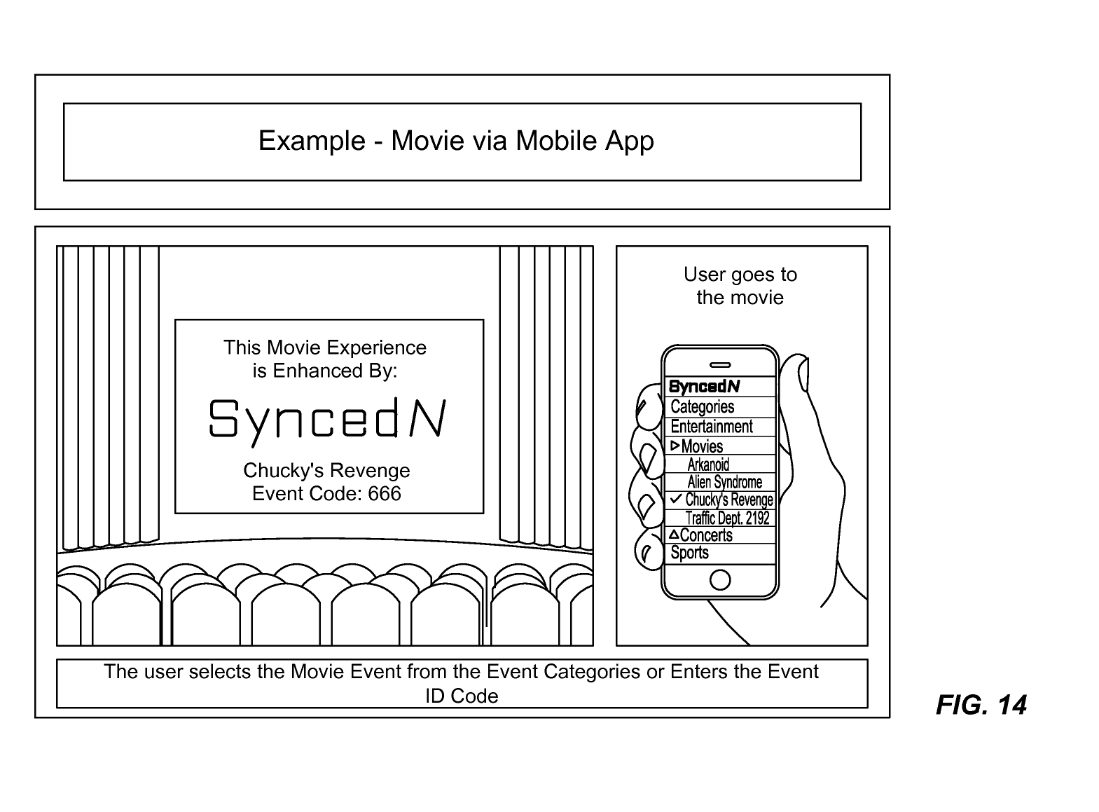

FIGS. 13-16 are screenshots to describe an illustrative example of the method and system described herein. In FIG. 13, there is shown content manager 120 (accessing computer configured as a server) uploading movie content to the network 130 via CP software. In FIG. 14, a user 175 goes to an event (movie) and selects, on their communications or mobile device (iPhone) a movie event from the event categories, “Chucky's Revenge” or enters an MovieID code “666”. The ID code is displayed on the movie screen, the event on the user device and movie screen.

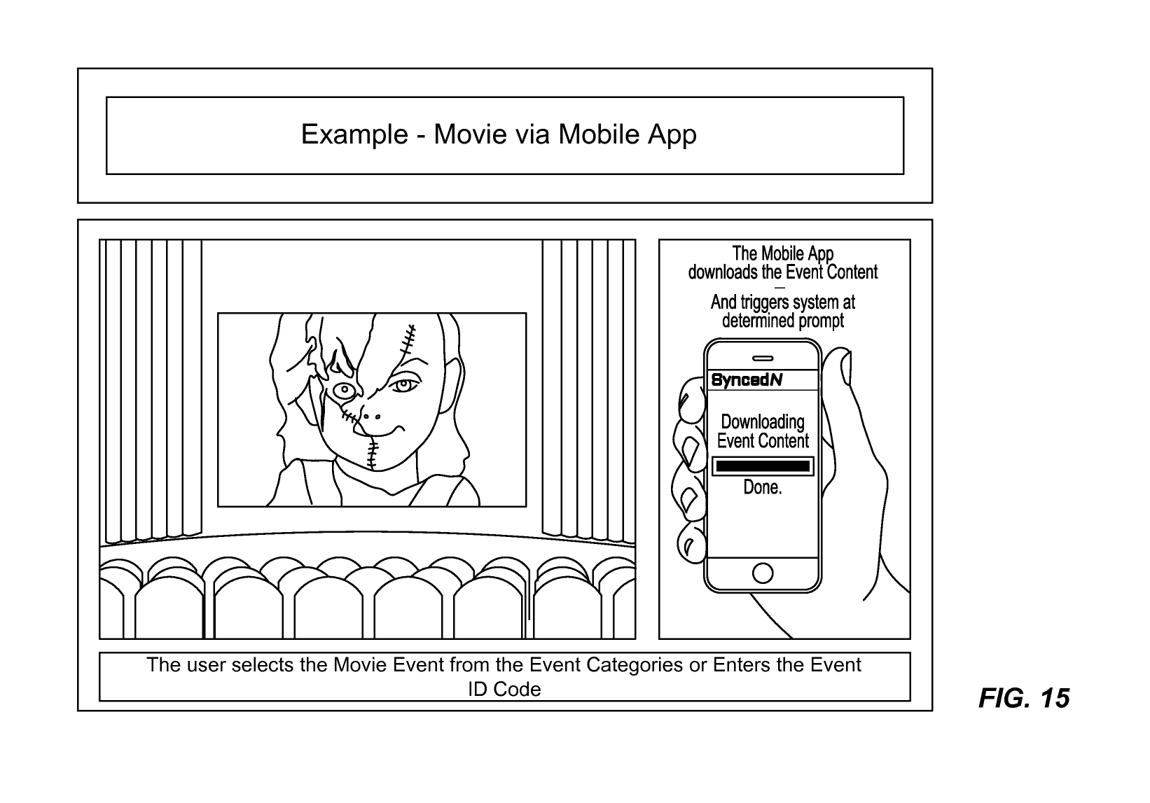

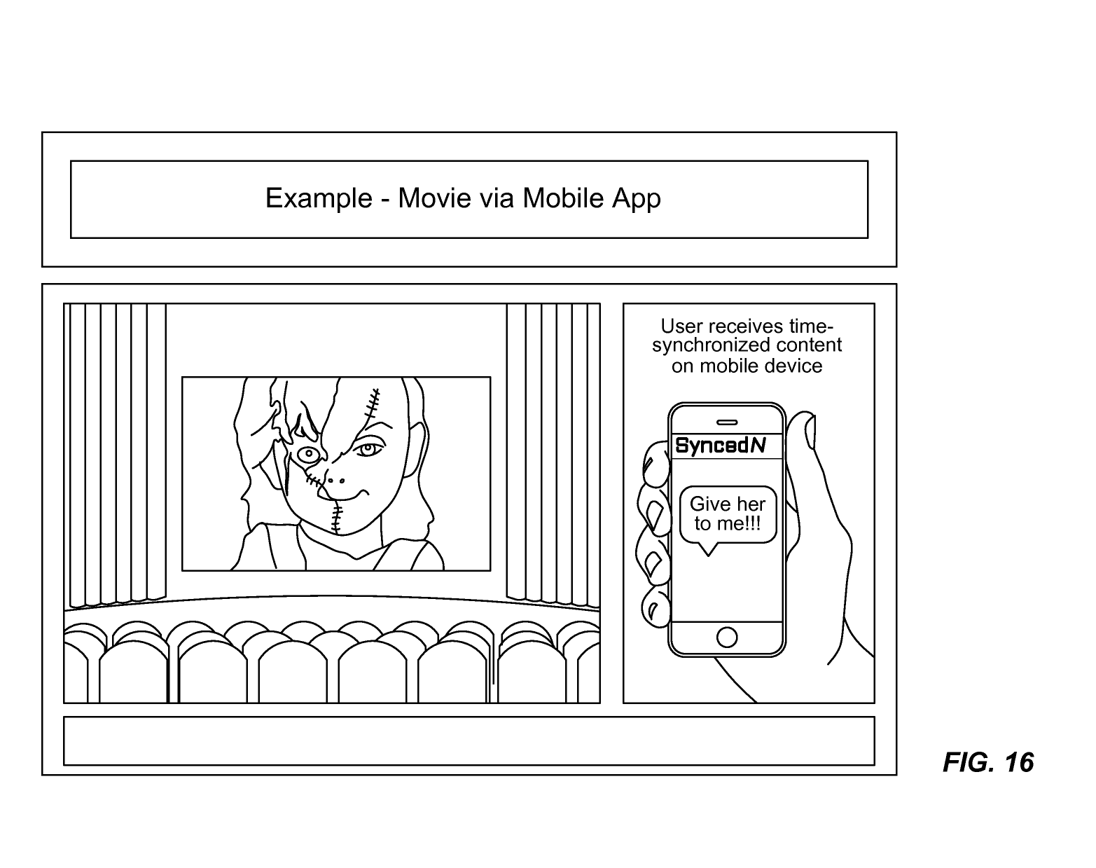

In FIG. 15, upon entering the code or selecting the event, content is downloaded “Give her to me!!!”, which could be the first sequence event in the sequence list. In FIG. 16, upon prompting, the user triggers “start synchronization” via the app, event-relevant content (sequence events in the sequence list) is then produced on the user communication or mobile device at precise time intervals that are in synchronization with a running time of the separate, software-synchronized event (Chucky's Revenge) after its event start time, as programmed by the content manager 120.

The example embodiments envision myriad event applications, including, but not limited to: theater movie releases, TV broadcast and DVD, live concert events, live sporting events, live entertainment events, live theater, live comedy shows, news broadcast, internet, live theme park interactive communications, interactive social media app—viral capability.

The example embodiments being thus described, it will be obvious that the same may be varied in many ways. Such variations are not to be regarded as departure from the example embodiments, and all such modifications as would be obvious to one skilled in the art are intended to be included in the following claims.

We claim:

1. A method of delivering time-sensitive, event-relevant digital content during a separate event being experienced by a user, comprising:
uploading content associated with the separate event to a network,
creating a sequence list from the newly uploaded content associated the event,
packaging the sequence list in a mobile software application,
delivering the mobile application from the network to a mobile device of the user, and
initiating a setup for an event start time associated with the separate event so that a plurality of sequence events of event-relevant digital content, contained in the sequence list, are run in the user's mobile device in synchronization with the event start time of the separate event.

2. The method of claim 1, wherein creating the sequence list includes inputting the plurality of sequence events, each sequence event having a specified start time after event start time, a duration, and an action.

3. The method of claim 2, wherein the action in a sequence event to be run is one of a text file, sound file, image file, device vibration, video file or combinations thereof that are presented on the mobile device at designated timings after the event start time occurs, and which are in synchronization with a running time of the separate event.

4. The method of claim 1, wherein initiating a setup for the event start time further includes:
running an event setup sub-process to determine an event ID so as to store the event ID and associated sequence list in a server at the network that delivers the mobile application to the user, and
running a location setup sub-process to determine the GPS location of the event so as to store GPS location data in the server for the event at the network.

5. The method of claim 1, further comprising:
iterating a start sequence sub-process that matches up a timeseed of the sequence list with the event start time associated with the separate event, to ensure that each of the plurality of sequence events of the sequence list to be presented on the user's mobile device is in synchronization with a running time of the separate event after its event start time.

6. The method of claim 1, further comprising:
iterating a run sequence sub-process that presents individual sequence events of the sequence list at specified timings on the user's mobile device that are in synchronization with a running time of the separate event after its event start time.

7. The method of claim 1, further comprising:
temporarily departing from running the sequence events of the sequence list,
posting a social narrative for upload to a social website on the network, and
returning to running the sequence events.

8. A mobile software application for delivering time-sensitive, event-relevant digital content on a mobile device of a user during a separate event being experienced by the user, comprising:
a sequence list stored in the application and including a plurality of sequence events of event-relevant digital content, contained in the sequence list, that are to be sequentially run in the user's mobile device in synchronization with an event start time of the separate event being experienced by the user,
a timeseed stored in the application for synchronizing the sequence list to the event start time of the separate event,
means for querying whether it is time to play a sequence event from the sequence list,
means for identifying the type of sequence event to be run, and
means for presenting the sequence event on the user's mobile device so that the sequence event is experienced by the user during the separate event that is also being experienced by the user.

9. The application of claim 8, further comprising:
means for accessing a social media hook so that the user sends information through the application to a social media site accessible on a network.

10. The application of claim 8, wherein each sequence event has a specified start time after event start time, a duration, and an action.

11. The application of claim 10, wherein the action in a sequence event to be run is one of a text file, sound file, image file, device vibration, video file or combinations thereof that are presented on the mobile device at designated timings after the event start time occurs and are in synchronization with a running time of the separate event.

12. The application of claim 8, wherein the separate event is one of a movie, concert, sporting event, TV broadcast, DVD content, internet broadcast, and radio broadcast.
